(19) United States
(12) Patent Application Publication
(10) Pub. No.: US 2018/0121268 A1
(43) Pub. Date: May 3, 2018

(54) ELECTRONIC DEVICE AND DATA TRANSFER METHOD THEREOF

(71) Applicant: SAMSUNG ELECTRONICS CO., LTD., Suwon-si (KR)

(72) Inventors: Ju Sun SONG, Pohang-si (KR); Jae Ook KWON, Yongin-si (KR); Young Ho CHOI, Suwon-si (KR)

(21) Appl. No.: 15/794,299

(22) Filed: Oct. 26, 2017

(30) Foreign Application Priority Data
Oct. 28, 2016 (KR) 10-2016-0142400

(51) Int. Cl. G06F 9/54; G06F 15/78; G06F 3/06

(52) U.S. Cl. CPC G06F 9/546; G06F 15/7821; G06F 15/781; H04L 67/12; G06F 3/0619; G06F 3/068; G06F 3/065

(57) ABSTRACT

An electronic device includes a memory storing software including an application, an inter-process communication (IPC) module supporting communication between processes, a first communication driver, and a second communication driver, and a processor executing the software stored in the memory. The processor is configured to determine, using the IPC module whether a destination of the data is inside the electronic device or outside the electronic device, if a transmission of data is requested from the IPC module by the application, to transmit the data through the first communication driver if the destination of the data is inside the electronic device, and to transmit the data through the second communication driver if the destination of the data is outside the electronic device.

### CROSS-REFERENCE TO RELATED APPLICATION

This application is based on and claims priority under 35 U.S.C. § 119 to a Korean patent application filed on Oct. 28, 2016 in the Korean Intellectual Property Office and assigned Serial number 10-2016-0142400, the disclosure of which is incorporated by reference herein in its entirety.

### TECHNICAL FIELD

The present disclosure relates generally to a method and apparatus in which an electronic device transmits data.

### BACKGROUND

With the development of digital technologies, various types of electronic products are being developed and distributed. In addition, services that are provided through interworking between electronic devices are increasing as communication technologies develop. In particular, with the development of a technology of Internet of things (IoT) or a home network, various electronic devices such as a smartphone, a TV, an air conditioner, a vehicle, and the like may be connected to each other to share data.

As an electronic device has a wide range of functionality, there is an increase in the number of electronic devices using a process-based platform. Unlike a thread-based platform, the memory space of each of the processes may be separated from each other in the process-based platform. For this reason, in the case where a share of data between processes is required, the process-based platform may transmit data to another process using the function of inter-process communication (IPC).

Data may be exchanged between processes included in the same electronic device by using IPC. However, it is impossible to transmit data to a process included in an external electronic device. In this case, socket communication may be used to transmit the data to the external electronic device. The socket communication may support both the inside and outside communication of an electronic device. However, the socket communication is slower than the IPC.

### SUMMARY

Various example embodiments of the present disclosure provide an electronic device that supports communication with the outside of the electronic device as well as communication with the inside of the electronic device through IPC and secures the transmission speed of data, and a data transfer method of the electronic device.

In accordance with an example aspect of the present disclosure, an electronic device includes a memory storing software including an application, an inter-process communication (IPC) module configured to support communication between processes, a first communication driver, and a second communication driver, and a processor configured to execute the software stored in the memory. The processor is configured, if a transmission of data is requested from the IPC module by the application, to determine, using the IPC module, whether a destination of the data is inside the electronic device or outside the electronic device, to transmit the data through the first communication driver if the destination of the data is inside the electronic device, and to transmit the data through the second communication driver if the destination of the data is outside the electronic device.

In accordance with an example aspect of the present disclosure, a data transfer method of an electronic device includes requesting, by an application, a transmission of data from an IPC module, determining, by the IPC module, a destination of the data, transmitting the data through a first communication driver if the destination of the data is inside the electronic device, and transmitting the data through a second communication driver if the destination of the data is outside the electronic device.

In accordance with an example aspect of the present disclosure, a computer-readable recording medium has recorded thereon a program that, when executed by a processor of an electronic device, causes the electronic device to perform operations including requesting, by an application, a transmission of data from an IPC module, determining, by the IPC module, a destination of the data, transmitting the data through a first communication driver if the destination of the data is inside the electronic device, and transmitting the data through a second communication driver if the destination of the data is outside the electronic device.

Other aspects, advantages, and salient features of the disclosure will become apparent to those skilled in the art from the following detailed description, which, taken in conjunction with the annexed drawings, discloses various example embodiments of the present disclosure.

According to various embodiments of the present disclosure, an application installed in an electronic device communicates with an external electronic device using an IPC without requiring a change in an existing code, thereby improving the transmission speed of data using the adjustment of a data processing priority and TCM.

### BRIEF DESCRIPTION OF THE DRAWINGS

The above and other aspects, features, and attendant advantages of the present disclosure will be more apparent and readily appreciated from the following detailed description, taken in conjunction with the accompanying drawings, in which like reference numerals refer to like elements, and wherein:

FIG. 1 is a block diagram illustrating an example configuration of an electronic device according to various example embodiments of the present disclosure;

FIG. 2 is a block diagram illustrating an example hierarchical structure of software, according to various example embodiments of the present disclosure;

FIGS. 3A and 3B are diagrams illustrating an example service registration process of an application, according to various example embodiments of the present disclosure;

FIGS. 4A and 4B are diagrams illustrating an example data transfer process, according to various example embodiments of the present disclosure;

FIG. 5 is a block diagram illustrating an example configuration of an electronic device, according to various example embodiments of the present disclosure;

FIG. 6 is a flowchart illustrating an example data transfer method of an electronic device, according to various example embodiments of the present disclosure; and

FIG. 7 is a flowchart illustrating an example data transfer method, according to various example embodiments of the present disclosure.

Throughout the drawings, it should be noted that like reference numbers are used to depict the same or similar elements, features, and structures.

### DETAILED DESCRIPTION

Hereinafter, various example embodiments of the present disclosure may be described with reference to accompanying drawings. Accordingly, those of ordinary skill in the art will recognize that modifications, equivalents, and/or alternatives on the various example embodiments described herein can be variously made without departing from the scope and spirit of the present disclosure. With regard to description of drawings, similar elements may be marked by similar reference numerals.

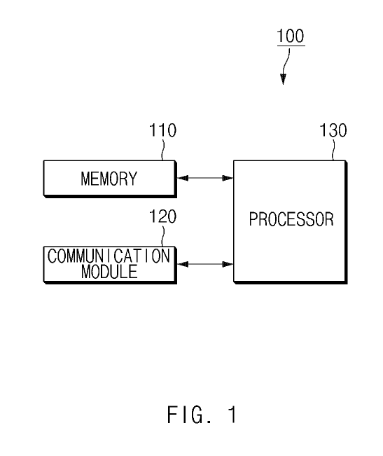

FIG. 1 is a block diagram illustrating an example configuration of an electronic device according to various example embodiments of the present disclosure.

Referring to FIG. 1, an electronic device 100 may include a memory 110, a communication module (e.g., including communication circuitry) 120, and a processor (e.g., including processing circuitry) 130.

According to an embodiment, the memory 110 may store an instruction, information, or data associated with the operations of the elements (e.g., the communication module 120 and the processor 130) included in the electronic device 100. For example, the memory 110 may store instructions, that, when executed, cause the processor 130 to perform various operations described in the present disclosure. For example, the instructions may be stored in the memory 110 after being implemented with software (or a program) or may be embedded in hardware, but is not limited thereto.

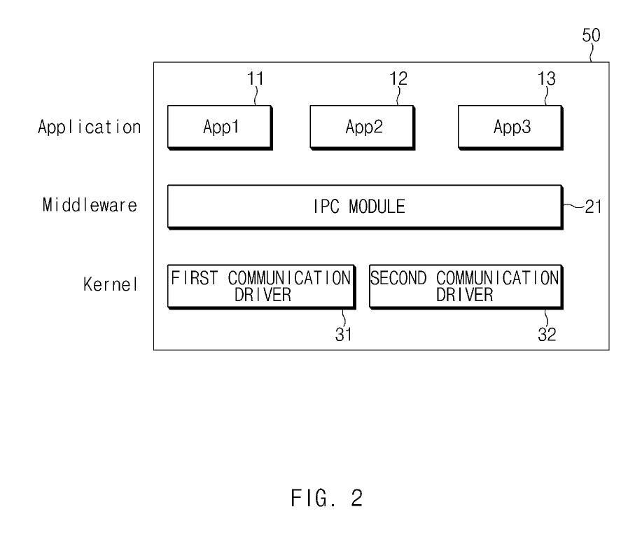

FIG. 2 is a block diagram illustrating an example hierarchical structure of software, according to various example embodiments of the present disclosure.

According to an embodiment, the hierarchical structure of software 50 may include an application, middleware, and a kernel. According to an embodiment, an application layer may include at least one application. For example, and without limitation, the application layer may include a first application 11, a second application 12, and a third application 13. According to an embodiment, a middleware layer may include an IPC module 21 (or an IPC library). According to an embodiment, the IPC module 21 may support communication between processes performed by the processor 130. According to various embodiments of the present disclosure, the IPC module 21 may support communication with an external electronic device as well as the communication between the processes in an electronic device. According to an embodiment, a kernel layer may include a first communication driver 31 and a second communication driver 32. The first communication driver 31 may be an IPC driver for the communication between the processes, and the second communication driver 32 may be a socket driver for the communication with the external electronic device. According to an embodiment, the first communication driver 31 may include a service list registered in the electronic device 100. For example, the first communication driver 31 may manage the service list including information about a service which an application (or an application stored in the memory 110) installed in the electronic device 100 provides or which is capable of being used.

TABLE 1

| service name | connection information |
|---|---|
| org.tizen.tv | — |
| org.youtube.streaming | 112.111.0.21(7171) |
| . . . | . . . |

Table 1 illustrates one non-limiting example of the service list. Referring to Table 1, the service list may include a service name field and a connection information field. For example, the connection information may include an Internet protocol (IP) address (e.g., 112.111.0.21) of the external electronic device and a port number (e.g., 7171) of a service. Since the connection information is necessary to communicate with an external electronic device, in the case where a service included in the service list is a service that an application included in the electronic device 100 provides, the connection information may not be included. For example, in the case where the application included in the electronic device 100 provides the first service (e.g., org.tizen.tv) included in the service list of Table 1, the connection information may not be included.

According to an embodiment, the first communication driver 31 may update the service list depending on a request of the application. For example, the first communication driver 31 may add a new service to the service list or may delete the service included in the service list. According to an embodiment, the service list may be shared with the IPC module 21.

According to an embodiment, the software 50 may include an application programming interface (API). According to an embodiment, the API may perform a mediation role such that the application communicates with the middleware or kernel to exchange data. For example, the data may include an instruction for performing a specific operation as well as contents such as an image, audio, or the like. The software 50 may be driven on an operating system (OS). For example, the OS may include Android™ or Tizen™.

According to an embodiment, the memory 110 may include a nonvolatile memory and/or a volatile memory. For example, the memory 110 may include a Flash memory being the nonvolatile memory and a random access memory (RAM) being the volatile memory.

According to an embodiment, the communication module 120 may include various communication circuitry and communicate with the external electronic device. For example, the communication module 120 may communicate with a user terminal device such as, for example, and without limitation, a smartphone, a tablet PC, a desktop PC, or the like. For another example, the communication module 120 may communicate with a home network device such as, for example, and without limitation, a TV, an audio device, a refrigerator, a washing machine, an air conditioner, or the like. As another example, the communication module 120 may communicate with a server providing contents or a service.

According to an embodiment, the communication module 120 may communicate with the external electronic device using the second communication driver 32. For example, the communication module 120 may generate a socket using the second communication driver 32 and may communicate with the external electronic device using the generated socket.

According to an embodiment, the communication module 120 may include a wired communication module and a wireless communication module. For example, the communication module 120 may include various communication circuitry including a wired communication module such as, for example, and without limitation, a high definition multimedia interface (HDMI), digital video/visual interactive (DVI), or a universal serial bus (USB), or the like. As another example, the communication module 120 may include various communication circuitry, such as, for example, and without limitation, a local area network (LAN) card that is connected to an access point (AP) and accesses an Internet network. As yet another example, the communication module 120 may include various communication circuitry including a wireless communication module such as, for example, and without limitation, Bluetooth, near field communication (NFC), wireless-fidelity (Wi-Fi), or the like.

According to an embodiment, the processor 130 may include various processing circuitry and perform data processing and/or an operation associated with communication or control of at least one other elements included in the electronic device 100. For example, the processor 130 may execute software, which is stored in the memory 110 or is embedded, and may process various instructions associated with the software.

According to an embodiment, the processor 130 may control overall operations of the electronic device 100. For example, if a data transfer is requested from an IPC module by a process (or an application) being performed, the processor 130 may process instructions included in the IPC module to transmit data to another process, the processor 130 is performing, or an external electronic device.

According to an embodiment, the electronic device 100 may include the at least one processor 130. For example, the electronic device 100 may include a plurality of the processors 130 which execute at least one function. According to an embodiment, the processor 130 may be implemented with a system on chip (SoC) that includes various processing circuitry, such as, for example, and without limitation, a dedicated processor, a central processing unit (CPU), a graphic processing unit (GPU), a memory, or the like.

According to an embodiment, while being executed by the processor 130, the application may request the data transfer. For example, the application may make a request for necessary data to another application or may transmit the data requested by another application.

According to an embodiment, after being executed by the processor 130, the application may provide a user with various services. According to an embodiment, the application itself may provide a service or may provide the service after operating in conjunction with another application. For example, the application may make a request for the necessary data to another application included in the electronic device 100 or an external electronic device (e.g., a server) and may provide a service based on data received from another application.

There is a need to share information about the service, which each application provides, such that a plurality of applications operates while being operating in conjunction with each other. As such, each application may perform a process of sharing information about service (or data), which is provided by each application, with another application.

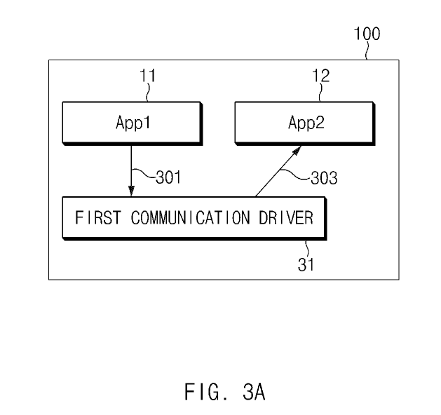

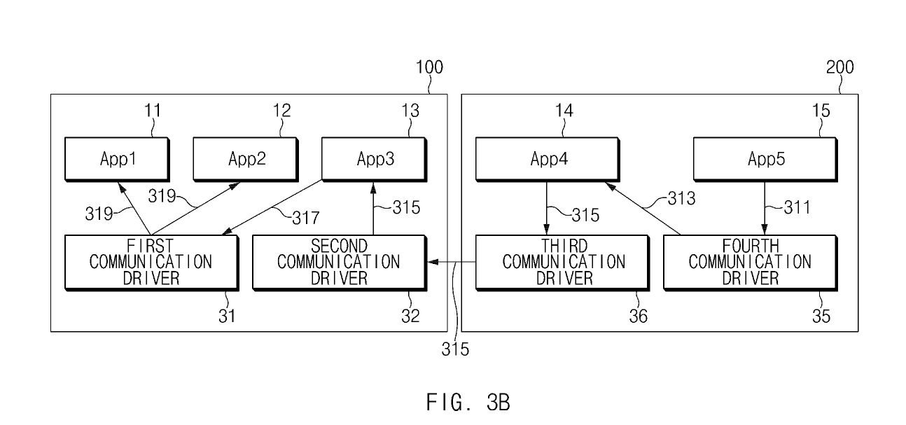

FIGS. 3A and 3B are diagrams illustrating an example service registration process of an application, according to various example embodiments of the present disclosure.

FIG. 3A illustrates an embodiment in which a service that an application (e.g., the first application 11 of FIG. 3A) included in the electronic device 100 provides is registered in the electronic device 100. FIG. 3B illustrates an embodiment in which a service that an application (e.g., a fifth application 15 of FIG. 3B) included in an external electronic device 200 provides is registered in the electronic device 100.

Referring to FIG. 3A, the electronic device 100 may include, for example and without limitation, the first application 11, the second application 12, and the first communication driver 31. According to an embodiment, the first communication driver 31 may be an IPC driver for communication between processes.

According to an embodiment, in operation 301, the first application 11 may register a new service in the first communication driver 31. For example, if the new service starts, the first application 11 may transmit information associated with the service to the first communication driver 31. The first communication driver 31 may add the new service, which the first application 11 provides, to a service list by using the information associated with the service.

According to an embodiment, if the new service is registered, in operation 303, the first communication driver 31 may notify the second application 12 that the new service is registered.

Referring to FIG. 3B, according to an example embodiment, illustrates an example in which the electronic device 100 (or a first electronic device) and the external electronic device 200 (or a second electronic device) are provided. According to an embodiment, the electronic device 100 may be a client device using a service, and the external electronic device 200 may be a server device providing the service.

According to an embodiment, the electronic device 100 may include, for example, and without limitation, the first application 11, the second application 12, the third application 13, the first communication driver 31, and the second communication driver 32. According to an embodiment, the external electronic device 200 may include, for example, and without limitation, a fourth application 14, the fifth application 15, a third communication driver 35, and a fourth communication driver 36. According to an embodiment, the third application 13 included in the electronic device 100 may be an application for sharing information about a service that the electronic device 100 provides, and the fourth application 14 included in the external electronic device 200 may be an application for sharing information about a service that the external electronic device 200 provides. According to an embodiment, each of the first communication driver 31 and the third communication driver 35 may be an IPC driver for communication between processes, and each of the second communication driver 32 and the fourth communication driver 36 may be a socket driver for communication with another electronic device. According to an embodiment, the third application 13 may generate a socket for communicating with the fourth application 14 by using the second communication driver 32, and the fourth application 14 may generate a socket for communicating with the third application 13 by using the fourth communication driver 36. The third application 13 and the fourth application 14 may transmit or receive data through the generated socket.

According to an embodiment, in operation 311, the fifth application 15 of the external electronic device 200 may register the new service in the third communication driver 35. For example, if the new service starts, the fifth application 15 may generate a socket associated with a service and may transmit information associated with the service to the third communication driver 35. For example, the information associated with the service may include a service name and connection information of a socket generated with regard to the service.

According to an embodiment, if the new service is registered by the fifth application 15, in operation 313, the third communication driver 35 of the external electronic device 200 may transmit information associated with the registered service to the fourth application 14.

According to an embodiment, in operation 315, the fourth application 14 of the external electronic device 200 may notify a device (e.g., the electronic device 100), which is connected through the socket, that the new service is registered. For example, the fourth application 14 may transmit the information associated with the service to the third application 13 through the socket connected with the third application 13 of the electronic device 100.

According to an embodiment, if the information associated with the service is received from the fourth application 14 of the external electronic device 200, in operation 317, the third application 13 may register the service in the first communication driver 31. For example, the first communication driver 31 may add the new service, which the fifth application 15 provides, to a service list using the information associated with the service.

According to an embodiment, if the new service is registered, in operation 319, the first communication driver 31 may notify the first application 11 and the second application 12 that the new service is registered.

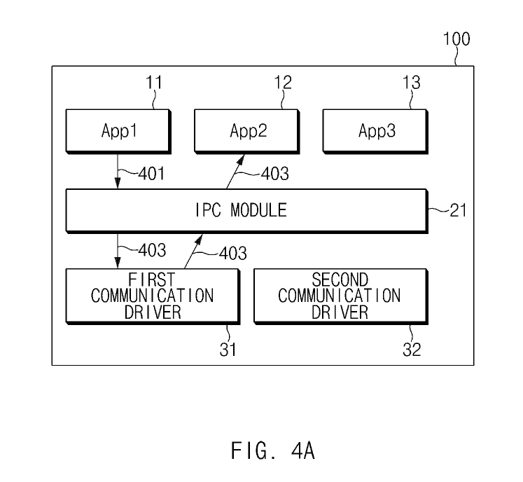

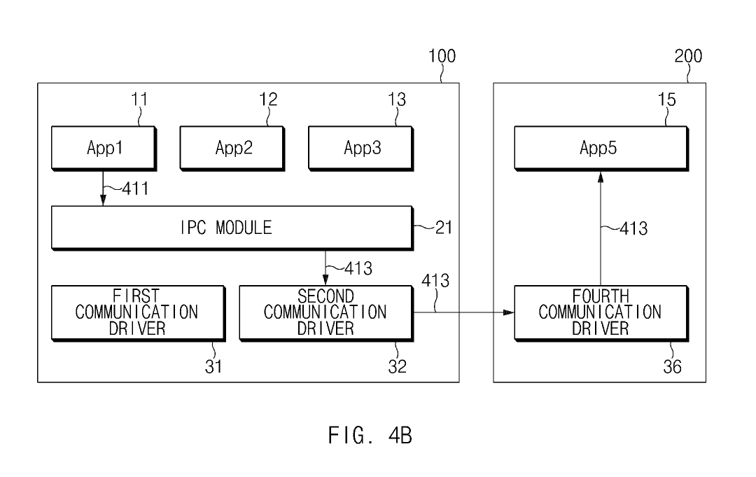

FIGS. 4A and 4B are diagrams illustrating an example data transfer process, according to various example embodiments of the present disclosure.

FIG. 4A illustrates an embodiment in which an application (e.g., the first application 11 of FIG. 4A) included in the electronic device 100 transmits data to another application (e.g., the second application 12 of FIG. 4A) included in the electronic device 100. FIG. 4B illustrates an embodiment in which an application (e.g., the first application 11 of FIG. 4A) included in the electronic device 100 transmits data to an application (e.g., the fifth application 15 of FIG. 4B) included in the external electronic device 200.

Referring to FIG. 4A, the electronic device 100 may include the first application 11, the second application 12, the third application 13, the IPC module 21, the first communication driver 31, and the second communication driver 32.

According to an embodiment, in operation 401, the first application 11 may make a request for a data transfer to the IPC module 21. For example, the first application 11 may make a request for a specific service to the second application 12 or may transmit specified data to the second application 12 in response to the service that the second application 12 requests. According to an embodiment, the data transfer request of the first application 11 may include a service name.

According to an embodiment, if the data transfer is requested by the first application 11, the IPC module 21 may determine whether the destination of data is inside the electronic device 100 or outside the electronic device 100. According to an embodiment, the IPC module 21 may determine the destination of the data based on the service name included in the data transfer request of the first application 11 and a service list registered in the first communication driver 31. For example, the IPC module 21 may compare the service name with a service name included in the service list to determine whether there is connection information corresponding to the service name in the service list. If there is no connection information corresponding to the service name in the service list, the IPC module 21 may determine that the destination of the data is inside the electronic device 100. If the connection information corresponding to the service name is present in the service list, the IPC module 21 may determine that the destination of the data is outside the electronic device 100. In the case where the first application 11 requests the data transfer from the second application 12 as the destination, the IPC module 21 may determine that there is no connection information corresponding to the service name of the second application 12 in the service list and may determine that the destination of the data is inside the electronic device 100.

According to an embodiment, if the destination of the data is inside the electronic device 100, in operation 403, the IPC module 21 may transmit the data through the first communication driver 31. For example, the IPC module 21 may transmit the data to the second application 12 through the first communication driver 31.

Referring to FIG. 4B, the electronic device 100 may include the first application 11, the second application 12, the third application 13, the IPC module 21, the first communication driver 31, and the second communication driver 32. According to the illustrated example embodiment, the electronic device 100 (or a first electronic device) and the external electronic device 200 (or a second electronic device) are provided. According to an embodiment, the electronic device 100 may be a device transmitting data, and the external electronic device 200 may be a device receiving the data.

According to an embodiment, the electronic device 100 may include the first application 11, the second application 12, the third application 13, the IPC module 21, the first communication driver 31, and the second communication driver 32. According to an embodiment, the external electronic device 200 may include the fifth application 15 and the fourth communication driver 36.

According to an embodiment, in operation 411, the first application 11 may make a request for a data transfer to the IPC module 21. For example, the first application 11 may make a request for a specific service to the fifth application 15 included in the second electronic device 200 or may transmit specified data to the fifth application 15 in response to the service that the fifth application 15 requests. According to an embodiment, the data transfer request of the first application 11 may include a service name.

According to an embodiment, if the data transfer is requested by the first application 11, the IPC module 21 may determine whether the destination of data is inside the electronic device 100 or outside the electronic device 100. According to an embodiment, the IPC module 21 may determine the destination of the data based on the service name included in the data transfer request of the first application 11 and a service list registered in the first communication driver 31. For example, the IPC module 21 may compare the service name with a service name included in the service list to determine whether there is connection information corresponding to the service name in the service list. If there is no connection information corresponding to the service name, the IPC module 21 may determine that the destination of the data is inside the electronic device 100. If the connection information corresponding to the service name is present, the IPC module 21 may determine that the destination of the data is outside the electronic device 100. In the case where the first application 11 requests the data transfer from the fifth application 15 as the destination, the IPC module 21 may determine that the connection information corresponding to the service name of the fifth application 15 is present in the service list and may determine that the destination of the data is outside the electronic device 100.

According to an embodiment, if the destination of the data is outside the electronic device 100, in operation 413, the IPC module 21 may transmit the data through the second communication driver 32. For example, the IPC module 21 may transmit the data to the fifth application 15 of the second electronic device 200 using the connection information (e.g., an IP address and a port number) corresponding to the service name. According to an embodiment, the second communication driver 32 of the electronic device 100 and the fourth communication driver 36 of the external electronic device 200 may be connected with each other through a socket, and the second communication driver 32 may transmit the data to the external electronic device 200 through the socket.

According to an embodiment, if the data transfer to the external electronic device 200 is requested by the IPC module 21, the second communication driver 32 may determine whether a socket for transmitting data is connected with the external electronic device 200 (e.g., the fourth communication driver 36). According to an embodiment, if the socket for transmitting data is not connected with the external electronic device 200, the second communication driver 32 may generate a socket and may connect the external electronic device 200 with the socket.

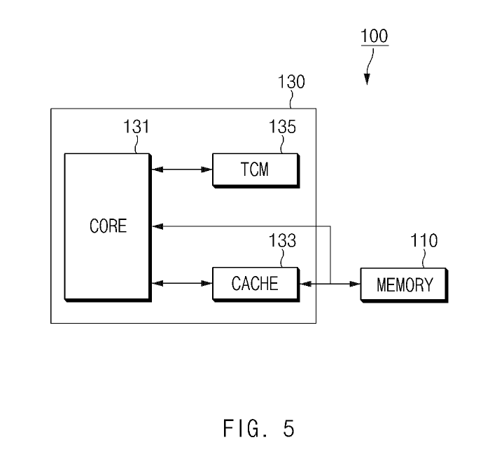

FIG. 5 is a block diagram illustrating an example configuration of an electronic device, according to various example embodiments of the present disclosure.

Referring to FIG. 5, the electronic device 100 may include the memory 110 and the processor (e.g., including processing circuitry) 130.

According to an embodiment, the processor 130 may include, for example, and without limitation, a core 131, a cache 133, and a tightly coupled memory (TCM) 135.

According to an embodiment, the core 131 may perform data processing and/or an operation associated with communication or control of at least one other elements included in the electronic device 100. According to an embodiment, the processor 130 may include at least one (e.g., two or four) core.

According to an embodiment, after being connected with the core 131, the cache 133 may store an instruction or information necessary for an operation of data of the core 131. For example, the core 131 may store data (or an instruction) or the processing result of the data in the cache 133.

According to an embodiment, after being connected with the core 131, the TCM 135 may store an instruction or information necessary for an operation of data of the core 131. For example, the core 131 may store data (or an instruction) or the processing result of the data in the TCM 135.

According to an embodiment, if there is a request of software (e.g., an application), the core 131 may store data in the TCM 135.

Both the cache 133 and the TCM 135 may be disposed at a location adjacent to the core 131, thereby improving the performance of the processor 130. However, it is difficult for the cache 133 to be applied to a real-time system that requires the predictability of time required to read or write data (or an instruction) due to non-deterministic characteristics. Unlike the cache 133, since the time required to read or write data (or an instruction) is predictable, the TCM 135 may be stably applied to the real-time system.

According to an embodiment, an application may request the high speed transmission of data from the IPC module. For example, when requesting the transmission of data, the application may insert a flag for requesting the high speed transmission. According to an embodiment, if the high speed transmission of the data is requested by an application, an IPC module (e.g., the IPC module 21 of FIG. 2) may determine whether the destination of the data, the high speed transmission of which is requested is inside the electronic device 100 or outside the electronic device 100. If the destination of the data is inside the electronic device 100, the IPC module may store the data in the TCM 135. For example, in the case where a first application included in the electronic device 100 transmits data to a second application at a high speed, the data may be copied from an area of the memory 110 assigned to the first application to an area of the TCM 135 assigned to the second application

According to an embodiment, the IPC module may set a processing priority of the data, the high speed transmission of which is requested, to a specified level or more. According to an embodiment, data (or an instruction) processed by the core 131 may be processed depending on a specified priority level. For example, the priority level may indicate an order and the share of time in which the core 131 processes the data. For example, data, the priority of which is set to be high may be preferentially processed by the core 131 and may be processed with a relatively large amount of time. According to an embodiment, the IPC module may set the processing priority of the data, the high speed transmission of which is requested, to be higher to minimize a context switching time and a delay time to wait, thereby improving the processing speed of the data.

According to an embodiment, if the high speed transmission of the data is requested by the application, the IPC module may identify the size of the data. If the size of the data is not smaller than a specified size, the IPC module may store the data in the TCM 135. For example, the specified size may be set to the capacity of the TCM 135 or less. The data, the size of which exceeds the specified size may not be stored in the TCM 135 because the TCM 135 has a limited size. Therefore, the IPC module may determine whether the data is stored in the TCM 135 depending on the size of the data.

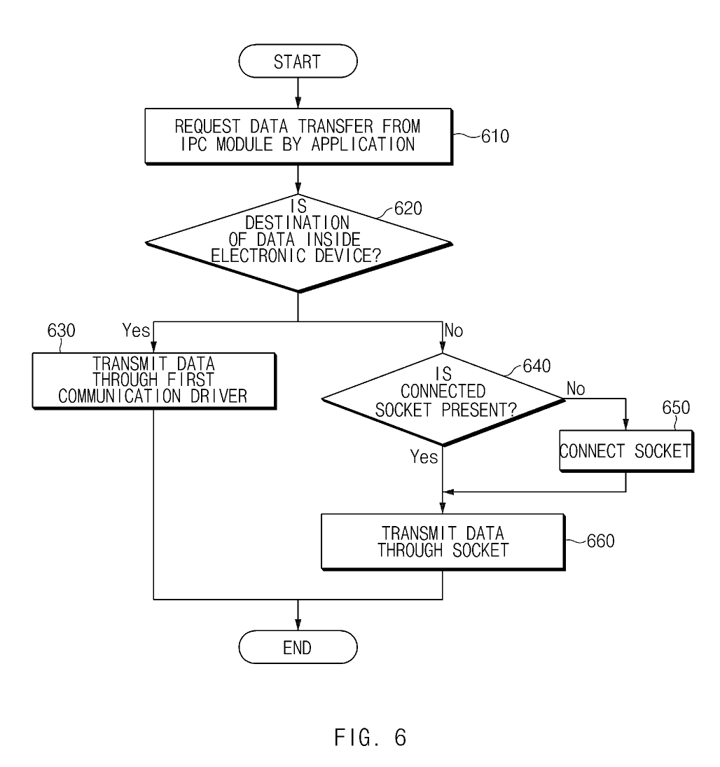

FIG. 6 is a flowchart illustrating an example data transfer method of an electronic device, according to various example embodiments of the present disclosure.

The flowchart illustrated in FIG. 6 may include operations that the above-described electronic device 100 processes. Therefore, although there are contents omitted below, contents described about the electronic device 100 with reference to FIGS. 1 to 5 may be applied to the flowchart illustrated in FIG. 6.

According to an embodiment, in operation 610, a data transfer may be requested from an IPC module by an application included in the electronic device 100. According to an embodiment, a data transfer request of the application may include a service name.

According to an embodiment, in operation 620, the electronic device 100 may determine whether the destination of data is inside the electronic device 100. According to an embodiment, the IPC module included in the electronic device 100 may determine the destination of the data based on the service name included in the data transfer request of the application and a service list registered in a first communication driver. For example, the IPC module may compare the service name with a service name included in the service list to determine whether there is connection information corresponding to the service name in the service list. If there is no connection information corresponding to the service name in the service list, the electronic device 100 may determine that the destination of the data is inside the electronic device 100. If the connection information corresponding to the service name is present in the service list, the electronic device may determine that the destination of the data is outside the electronic device 100.

According to an embodiment, if it is determined in operation 620 that the destination of the data is inside the electronic device 100, in operation 630, the electronic device 100 may transmit the data through the first communication driver. For example, the electronic device 100 may transmit the data to another application included inside the electronic device 100.

According to an embodiment, if it is determined in operation 620 that the destination of the data is not inside the electronic device 100 (or if the destination of the data is the external electronic device 200), in operation 640, the electronic device 100 may determine whether there is a socket connected with the external electronic device 200 to transmit the data.

According to an embodiment, in operation 640, if the socket connected with the external electronic device 200 is present, in operation 660, the electronic device 100 may transmit the data through the socket. For example, the second communication driver included in the electronic device 100 may be connected with an external electronic device through the socket, and the electronic device 100 may transmit the data through the socket connected with the external electronic device.

According to an embodiment, in operation 640, if there is no socket connected with the external electronic device 200, in operation 650, the electronic device 100 may connect the socket for transmitting the data with the external electronic device 200. For example, the electronic device 100 may generate the socket by using the second communication driver and may connect the generated socket with the external electronic device.

According to an embodiment, if the external electronic device 200 and the socket are connected with each other, in operation 660, the electronic device 100 may transmit the data through the connected socket.

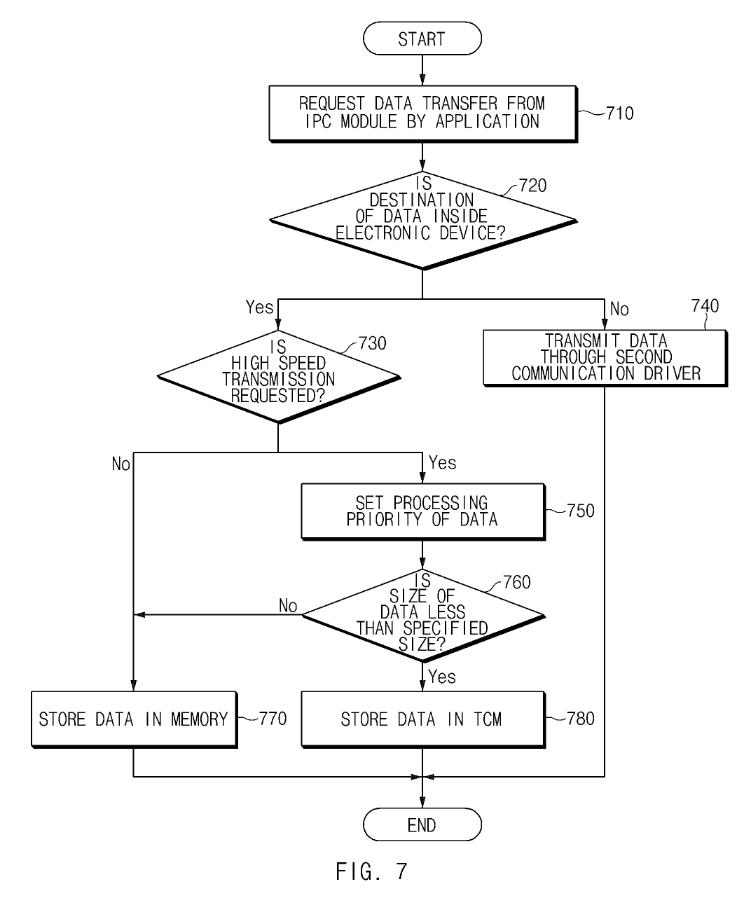

FIG. 7 is a flowchart illustrating an example data transfer method, according to various example embodiments of the present disclosure.

The flowchart illustrated in FIG. 7 may include operations that the above-described electronic device 100 processes. Therefore, although there are contents omitted below, contents described about the electronic device 100 with reference to FIGS. 1 to 5 may be applied to the flowchart shown in FIG. 7.

According to an embodiment, in operation 710, a data transfer may be requested from an IPC module by an application included in the electronic device 100. According to an embodiment, a data transfer request of the application may include a service name.

According to an embodiment, in operation 720, the electronic device 100 may determine whether the destination of data is inside the electronic device 100. According to an embodiment, the IPC module included in the electronic device 100 may determine the destination of the data based on the service name included in the data transfer request of the application and a service list registered in a first communication driver. For example, the IPC module may compare the service name with a service name included in the service list to determine whether there is connection information corresponding to the service name in the service list. If there is no connection information corresponding to the service name in the service list, the electronic device 100 may determine that the destination of the data is inside the electronic device 100. If the connection information corresponding to the service name is present in the service list, the electronic device may determine that the destination of the data is outside the electronic device 100.

According to an embodiment, if it is determined in operation 720 that the destination of the data is outside the electronic device 100, in operation 740, the electronic device 100 may transmit the data through the second communication driver.

According to an embodiment, if it is determined in operation 720 that the destination of the data is inside the electronic device 100, in operation 730, the electronic device 100 may determine whether the high speed transmission of the data is requested by the application. For example, the IPC module included in the electronic device 100 may determine whether a flag for requesting the high speed transmission is inserted into a request to transmit data.

According to an embodiment, if it is determined in operation 730 that the high speed transmission of the data is not requested, in operation 770, the electronic device 100 may store the data in a memory. For example, in the case where a first application included in the electronic device 100 transmits the data to a second application, the data may be copied from the area of the memory 110 assigned to the first application to the area of the memory 110 assigned to the second application through the first communication driver.

According to an embodiment, if it is determined in operation 730 that the high speed transmission of the data is requested, in operation 750, the electronic device 100 (e.g., the IPC module) may set the processing priority of the data to a specified level or more.

According to an embodiment, in operation 760, the electronic device 100 (e.g., the IPC module) may determine whether the size of the data is less than the specified size. For example, the specified size may be set to the capacity of a TCM or less.

According to an embodiment, if it is determined in operation 760 that the size of the data exceeds the specified size, in operation 770, the electronic device 100 (e.g., the IPC module) may store the data in the memory. For example, in the case where the first application included in the electronic device 100 transmits the data to the second application, the data may be copied from the area of the memory 110 assigned to the first application to the area of the memory 110 assigned to the second application through the first communication driver.

According to an embodiment, if it is determined in operation 760 that the size of the data is not greater than (i.e., is less than) the specified size, in operation 780, the electronic device 100 (e.g., the IPC module) may store the data in the TCM. For example, in the case where the first application included in the electronic device 100 transmits the data to the second application at a high speed, the data may be copied from the area of the memory 110 assigned to the first application to the area of the TCM 135 assigned to the second application through the first communication driver.

According to various example embodiments, at least a part of an apparatus (e.g., modules or functions thereof) or a method (e.g., operations) may be, for example, implemented by instructions stored in a computer-readable storage media in the form of a program module. The instruction, when executed by a processor, may cause the processor to perform a function corresponding to the instruction. The computer-readable recording medium may include a hard disk, a floppy disk, a magnetic media (e.g., a magnetic tape), an optical media (e.g., a compact disc read only memory (CD-ROM) and a digital versatile disc (DVD), a magneto-optical media (e.g., a floptical disk)), an embedded memory, and the like. The instruction may include codes created by a compiler or codes that are capable of being executed by an interpreter.

According to various example embodiments, operations executed by modules, program modules, or other elements may be executed by a successive method, a parallel method, a repeated method, or a heuristic method, or at least one part of operations may be executed in different sequences or omitted. Alternatively, other operations may be added.

While the present disclosure has been illustrated and described with reference to various example embodiments thereof, it will be understood by those skilled in the art that various changes in form and details may be made therein without departing from the spirit and scope of the present disclosure as defined by the appended claims and their equivalents.

What is claimed is:

1. An electronic device comprising:
a memory configured to store software including an application, an inter-process communication (IPC) module configured to support communication between processes, a first communication driver, and a second communication driver; and
a processor configured to execute the software stored in the memory,
wherein the processor is configured to:
determine, via the IPC module, whether a destination of the data is inside the electronic device or outside the electronic device if a transmission of data is requested from the IPC module by the application;
transmit the data through the first communication driver if the destination of the data is inside the electronic device; and
transmit the data through the second communication driver if the destination of the data is outside the electronic device.

2. The electronic device of claim 1, wherein the first communication driver comprises an IPC driver configured to provide communication between processes performed by the processor, and
wherein the second communication driver comprises a socket driver configured to provide communication with an external electronic device.

3. The electronic device of claim 1, wherein the first communication driver includes a service list including a service name and connection information, and
wherein the processor is configured to:
add a name of a new service and connection information of the new service to the service list if a request to register the new service is received from an external electronic device through the second communication driver; and
notify the application of the registration of the new service.

4. The electronic device of claim 1, wherein the first communication driver includes a service list including a service name and connection information, and
wherein the processor is configured to:
add a name of a new service to the service list if a registration of the new service is requested from the first communication driver by a first application; and
notify a second application of the registration of the new service.

5. The electronic device of claim 1, wherein the first communication driver includes a service list including a service name and connection information, and
wherein the processor is configured to:
determine whether the destination of the data is inside or outside the electronic device, based on the connection information included in the service list.

6. The electronic device of claim 5, wherein the processor is configured to:
compare a service name included in a request to transmit the data with the service name included in the service list;
determine that the destination of the data is inside the electronic device if the connection information corresponding to the service name is absent from the service list; and
determine that the destination of the data is outside the electronic device if the connection information corresponding to the service name is present in the service list.

7. The electronic device of claim 1, wherein the processor is configured to:
determine whether there is a socket connected by the second communication driver to transmit the data if the destination of the data is outside the electronic device; and
connect an external electronic device with the socket using connection information of a service associated with the data if there is no connected socket.

8. The electronic device of claim 1, wherein the processor includes a tightly-coupled memory (TCM), and
wherein the processor is configured to:
store the data in the TCM if the destination of the data is inside the electronic device and a high speed transmission of the data is requested by the application.

9. The electronic device of claim 8, wherein the processor is configured to:
store the data in the TCM, after setting a processing priority of the data to a specified level or higher using the IPC module if the high speed transmission of the data is requested by the application.

10. The electronic device of claim 8, wherein the processor is configured to:
store the data in the TCM if a size of the data is less than a specified size.

11. A data transfer method of an electronic device, the method comprising:
requesting, by an application, a transmission of data from an IPC module;
determining, by the IPC module, a destination of the data;
transmitting the data through a first communication driver if the destination of the data is inside the electronic device; and
transmitting the data through a second communication driver if the destination of the data is outside the electronic device.

12. The method of claim 11, wherein the first communication driver comprises an IPC driver configured to provide communication between processes performed by a processor, and
wherein the second communication driver comprises a socket driver configured to provide communication with an external electronic device.

13. The method of claim 11, further comprising:
receiving, by the second communication driver, a request to register a new service from an external electronic device;
adding, by the first communication driver, a name of the new service and connection information of the new service to a service list; and
notifying, by the first communication driver, the application of registration of the new service.

14. The method of claim 11, further comprising:
requesting, by a first application, a registration of a new service from the first communication driver;
adding, by the first communication driver, a name of the new service to a service list; and
notifying, by the first communication driver, a second application of registration of the new service.

15. The method of claim 14, wherein the determining of the destination of the data includes:
determining, by the IPC module, whether the destination of the data is inside or outside the electronic device, based on connection information included in the service list.

16. The method of claim 15, wherein the determining of whether the destination of the data is inside or outside the electronic device, based on the connection information includes:
comparing a service name included in a request to transmit the data with the service name included in the service list;
determining that the destination of the data is inside the electronic device if the connection information corresponding to the service name is absent from the service list; and
determining that the destination of the data is outside the electronic device if the connection information corresponding to the service name is present in the service list.

17. The method of claim 11, further comprising:
determining whether there is a socket connected by the second communication driver to transmit the data if the destination of the data is outside the electronic device; and
connecting, by the second communication driver, an external electronic device with the socket using connection information of a service associated with the data if there is no connected socket.

18. The method of claim 11, further comprising:
storing the data in a TCM if the destination of the data is inside the electronic device and a high speed transmission of the data is requested by the application.

19. The method of claim 18, further comprising:
setting, by the IPC module, a processing priority of the data to a specified level or higher if the high speed transmission of the data is requested by the application; and
storing the data in the TCM.

20. A computer-readable recording medium having recorded thereon a program that, when executed by a processor, causes an electronic device to perform operations comprising:
requesting, by an application, a transmission of data from an IPC module;
determining, by the IPC module, a destination of the data;
transmitting the data through a first communication driver if the destination of the data is inside the electronic device; and
transmitting the data through a second communication driver if the destination of the data is outside the electronic device.
